(19) United States
(12) Patent Application Publication
(10) Pub. No.: US 2008/0246775 A1
(43) Pub. Date: Oct. 9, 2008

(54) Display System and a Method of Operating a Displaying System

(75) Inventors: Andrew John Fisher, Cambridge (GB); Timothy Holroyd Glauert, Cambridgeshire (GB)

Correspondence Address: BROOKS KUSHMAN P.C., 1000 TOWN CENTER, TWENTY-SECOND FLOOR, SOUTHFIELD, MI, 48075, US

(73) Assignee: DISPLAYLINK (UK) LIMITED, Cambridge (GB)

(21) Appl. No.: 12/065,031

(22) PCT Filed: Aug. 24, 2006
(86) PCT No.: PCT/GB2006/003149

§ 371 Date: Feb. 27, 2008

(30) Foreign Application Priority Data
Aug. 27, 2005 (GB) 0517564.1
Nov. 23, 2005 (GB) 0523793.8

(51) Int. Cl. G09G 5/04; G09G 5/30; G06F 13/14

(52) U.S. Cl. 345/589; 345/617; 345/520

(57) ABSTRACT

A display system comprises a plurality of display devices, a plurality of display control devices, each display device O connected to at least one display control device, a data processing device and a data network, the data processing device connected to each display control device via the data network. The data processing device is arranged to transmit a control signal to a display control device, the control signal comprising video signal configuration data, the video signal configuration data comprising timing and frequency data. Alternatively or additionally, the control signal can comprise at least one of power saving data, memory use data, brightness and contrast data, colour temperature data or display address data.

This invention relates to a display system and to a method of operating a display system. The invention provides network-based control of display timings, power saving modes, and memory-to-pixel mappings.

When a processing device such as a computer is connected to a display, a wide variety of parameters are used to describe how that display is driven. In the most common case of a PC connecting to a monitor using a VGA or DVI connection, these parameters include timing and frequency settings for the pixel clock and the horizontal and vertical sync signals. Changing these parameters causes a change in the resolution of the display, the position of the image on the screen, the refresh rate of the display, and so forth. On most displays, the actual image is then created by reading pixel values from a framebuffer memory at an appropriate rate and sending them to the display device at appropriate times, which will depend on the aforementioned parameters. The memory locations used for this process, and the amount of display memory involved, also affect various aspects of the display and may be dependent on the timing signals specified.

For the processing device to configure itself appropriately, it needs to know something about the display to which it is connected, since different displays will have different ranges of parameters that they can accept. Most modern display devices are able to identify themselves and some of their characteristics to the processing device, which can then make decisions about which configurations are the most appropriate. One such system used for this (in the case of VGA connections) is the VESA DDC (Display Data Channel) standard. On a conventional PC with an attached monitor, the graphics card in the PC communicates with the display and reports what it finds to the graphics driver and other related software. This software attempts to determine which configurations the display is likely to support, and selects an appropriate one. User preferences may be taken into account; the user may be presented with a list of available configurations and be able to make a selection from them. A typical menu might allow the user to select from resolutions of 800×600, 1024×768 or 1280×1024, and refresh frequencies of 60 Hz, 70 Hz, or 75 Hz, for example. In situations where the display is a conventional television, the configuration may consist of making a choice between TV signalling standards such as PAL, SECAM or NTSC. A combination of the device driver and the graphics card will then take this selection and select the appropriate parameters to drive the display in the mode specified. The user may also be able to adjust such things as the horizontal and vertical size and alignment of the image, which will also result in changes to the parameters. The user may also be able to specify the colour depth, i.e. the number of bits per pixel involved in generating the image. This will determine the process and timing by which the pixel values are read from memory and sent to the display.

Graphics systems routinely allow detailed timing parameters to be given to graphics adapters, but this information does not go over a network. Network display systems, such as those using thin clients, typically store a fixed set of timing parameters on the device itself and do not allow these to be set remotely. Such a system is used in, for example, an airport where each display is controlled by a device, usually a computer, with the computers connected via a network to a central server. The software and hardware on each computer needs to support the different modes that the corresponding display device uses in order to drive that display device. This requires a relatively high level device to drive the display device and can sometimes mean that if the display device is changed to a model not previously in use with the computer, the new display device cannot be driven without some updating of the software used by the computer. This ‘distributed configuration’ is complex and expensive to manage.

It is therefore an object of the invention to improve upon the known art.

According to a first aspect of the present invention, there is provided a display system comprising a plurality of display devices, a plurality of display control devices, each display device connected to at least one display control device, a data processing device and a general purpose data network, the data processing device connected to each display control device via the data network, the data processing device being arranged to transmit a control signal to a display control device, the control signal comprising video signal configuration data, the video signal configuration data comprising timing and frequency data.

According to a second aspect of the present invention, there is provided a method of operating a display system, the display system comprising a plurality of display devices, a plurality of display control devices, each display device connected to at least one display control device, a data processing device and a general purpose data network, the data processing device connected to each display control device via the data network, the method comprising transmitting a control signal from the data processing device to a display control device, the control signal comprising video signal configuration data, the video signal configuration data comprising timing and frequency data.

The invention allows a wide range of video modes to be supported by the display control device rather than being constrained by a pre-determined set of parameters. This allows the control device to support modes that weren't defined when the control device was made. It allows a faulty device to be swapped out for a replacement without the new one having to be configured manually, and allows multiple control devices to be configured automatically, thus simplifying administration, especially remote administration.

The video configuration data can be modified at any time during the operation of the system, not just at startup time. This allows such parameters as resolution or brightness to be changed according to the needs of the system, of some particular application, or in response to some change in the hardware configuration such as a display device being replaced.

The benefits are greater flexibility and efficiency in the display control device and a more future-proof design. The flexibility avoids the need to supply different units to different markets, with obvious commercial benefits. The future-proofing of the design also increases the perceived value to customers wishing to avoid technology that will become obsolete when new display devices are invented. The display control device may also be manufacturable at a lower cost.

According to a third aspect of the present invention, there is provided a display system comprising a plurality of display devices, a plurality of display control devices, each display device connected to at least one display control device, a data processing device and a general purpose data network, the data processing device connected to each display control device via the data network, the data processing device being arranged to transmit a control signal to a display control device, the control signal comprising at least one of power saving data, memory use data, brightness and contrast data, colour temperature data or display address data.

The selection of power-saving modes may also be controlled remotely. This can result in substantial power savings across an organisation, for example, where large numbers of monitors may be put into a power-saving mode when the office is closed. Sometimes it can also be desirable to switch off displays in an unoccupied room for security reasons. For many display devices, at least some of the power-saving modes are initiated by manipulation of the video timing signals, and therefore combining the two aspects of the invention makes sense.

Controlling the memory use in the device allows optimal configuration for the attached display and selected video modes, but can also take into account the nature of the video data likely to be sent to the device. As a simple example, if the data-processing device knows that, for the time being, all data sent to the device will be in the form of 16-bit pixels with 5 bits representing each of the red and blue values and 6 bits representing the green, it may be able to configure the memory use in the device to match this. This will improve the efficiency of handling the video data and will make better use of the memory on the device, and probably of the network bandwidth, than in the case where, for example, it is assumed that the display will always be driven with 32 bits per pixel.

Embodiments of the present invention will now be described, by way of example only, with reference to the accompanying drawings, in which:

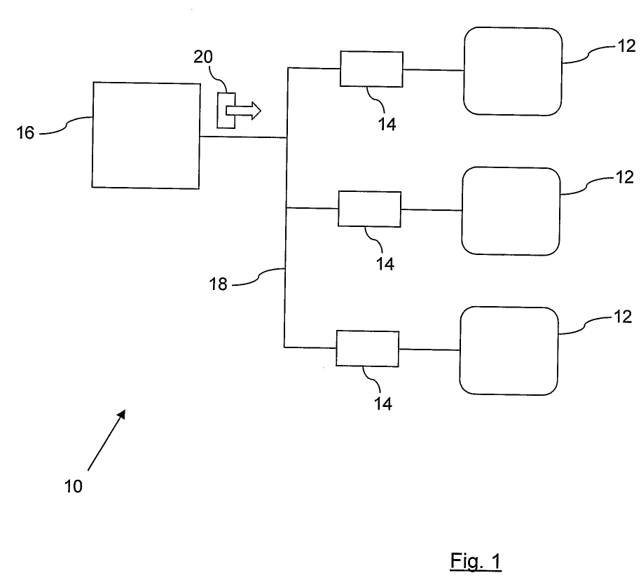

FIG. 1 is a schematic diagram of a display system, and

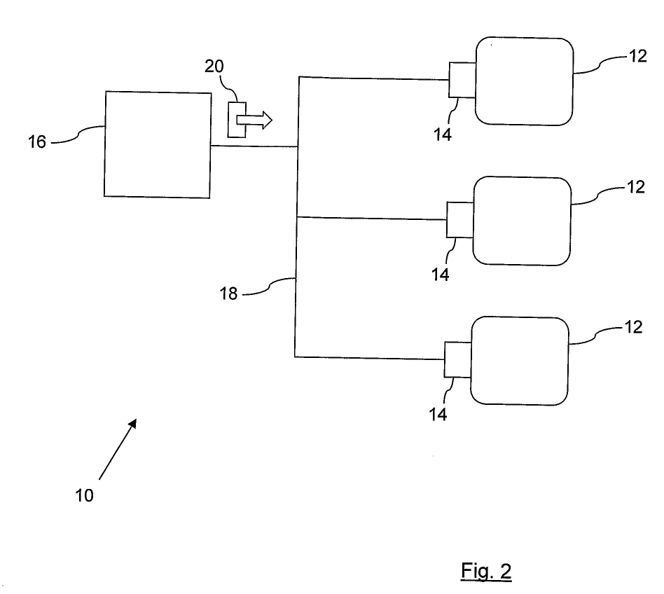

FIG. 2 is a schematic diagram of a second embodiment of the display system.

The display system 10 in FIG. 1 includes a plurality of display devices 12 and a plurality of display control devices 14. Each display device 12 is connected to a display control device 14, the display control device 14 driving the image displayed by the display device 12. The system 10 also includes a data processing device 16 and a data network 18, the data processing device 16 connected to each display control device 14 via the data network 18. The data network is a general-purpose data network, such as that described in the Ethernet and 802.11 family of standards.

FIG. 2 shows an alternative embodiment of the display system 10, in which the display control devices 14 are integral with their respective display devices 12. The data processing device 16 communicates with the various display control devices 14 via the general purpose data network 18.

In both embodiments, the data processing device 16 is arranged to transmit a control signal 20 to each display control device 14, the control signal 20 comprising video signal configuration data, the video signal configuration data comprising timing and frequency data.

In the context of a networked control device 14 driving a display 12, detailed video-signal configuration information 20 is sent to the device 14 over the network 18 rather than being pre-configured in the device 14. The device 14 is able to transmit over the network 18 information about the display 12 that is connected to it. A remote entity on the network, typically a PC 16, can make decisions about the appropriate configuration based on this or other information, and send the configuration to the control device 14, which will then drive the display 12 accordingly.

Similarly, decisions about the selection of power-saving modes and memory use on the display device 12 may also be sent to the control device 14 over the network 18, and the device 14 can cause those modes to be selected on the display 12. Lastly, the address from which data is rastered to the display 12 can also be sent over the network 18 in the control signal 20 rather than being fixed in the device or chosen from a limited set of options.

The system relates chiefly to simpler devices 14 that drive displays 12 and which are connected to a network 18, such as thin clients, or display network adaptors. These may have little in the way of local storage or local user interfaces. Traditionally, such a control device will have a configuration mode where the basic resolution and frequency of the display can be selected from those supported by the device. As a result, the displays that may be connected to the device are limited to those whose video timing parameters are known by the device.

In the system as shown in the embodiments of FIGS. 1 and 2, the networked device 14 is able to receive the full range of video interface configuration information over the network 18, so avoiding the need to store a limited subset locally. The precise timings and frequencies, rather than simpler concepts like ‘1024×768’, are specified in the network traffic. If the device is manufactured, for example, when the common resolutions used by displays are 1024×768 and 1280×1024, and then customer preferences for wide screens cause resolutions of 1280×768 or 1280×854 to become popular, the device 14 can be configured to drive these new displays 12 even though the standard was not known at the time of its manufacture, or was not common enough to be implemented, for example, in firmware updates. The system 10 as a whole can therefore conveniently be updated to cope with new models of displays and make decisions about how best to drive them.

The networked display control device 14 will receive this control signal 20 from a data processing device 16 on the network 18, such as a PC or a server, and the data transmission may be initiated from either end—a ‘push’ from the data processing device 16, or a request from the networked display control device 14. The networked display control device 14 can be made simpler and at a lower cost as a result of not having to provide so many features itself. It will also have a longer useful life. A data processing device may have control over multiple display devices 12, and can provide configuration for all of them. A display may also be controlled by multiple data processing devices, though not, typically, at the same time.

An important use of the invention is in the situation where multiple displays need to be used together, for example as part of a ‘video-wall’ type display. It is desirable for the resolution, brightness and contrast and colour temperature of the displays to be matched, and in some cases for their screen refreshes to be synchronised to avoid the appearance of flicker across the display as a whole. When displays are connected to a network, this process of manual or automatic calibration becomes much simpler if these parameters may all be controlled over the network in the manner of the present invention. Sometimes a group of otherwise independent displays may need to be controlled together for other reasons. An example might be information screens in a theatre, which may be displaying a variety of different types of information but must all be dimmed when the performance starts. Such functionality is readily available when the displays are driven in the manner of the present invention.

Many display devices 12 can be switched into low-power modes when not in use. This can cause the display to dim, or be completely switched off. In the traditional PC model, this is generally initiated by the PC when it has not received any user input for some time.

The process of putting a display into a power-saving mode may be accomplished in various ways. For many models of display it can be accomplished by modifying the video signals, for example by switching off one of the synchronisation signals. For others, it may be achieved through the use of the DDC protocols mentioned above, for example. By making some or all of this process accessible through the network 18, an organisation may have much greater information about and control over its power usage. An airport which has no passengers in the early hours of the morning, for example, may choose to dim or switch off every display in the airport, causing both direct electricity savings and indirect ones, for example through reduced air-conditioning requirements. It may also prolong the life of the displays. Similarly, if no flights for a particular terminal or airline are expected during a particular period, the displays in that part of the airport could be switched off while others are unaffected.

Most display devices show an image that is formed by the driving device reading pixel values from a framebuffer memory, interpreting those as pixel colours, and sending them to the display in an appropriate way. In this aspect, too, there are configuration parameters which are conventionally pre-configured in the driving device and yet which may advantageously be sent to that device over the network 18. They include the number of bits to be used to represent a pixel, the way those bits are interpreted to form pixel colours, the way they are packed into memory locations, the amount of memory to be used, the number of different screen images which may be stored at the device and the starting address of the memory used for each page in the device.

By making these parameters also controllable over the network 18 in the control signal 20, the data processing device 16 can select them to make most efficient use of the memory for the selected configuration or to be most efficient for storing or handling the image data that will be sent to the display device 12 over the network 18.

1. A display system comprising a plurality of display devices, a plurality of display control devices, each display device connected to at least one display control device, a data processing device and a general purpose data network, the data processing device connected to each display control device via the data network, the data processing device being arranged to transmit a control signal to a display control device, the control signal comprising video signal configuration data, the video signal configuration data comprising timing and frequency data.

2. A display system according to claim 1, wherein the control signal further comprises power saving data.

3. A display system according to claim 1, wherein the control signal further comprises display address data.

4. A display system according to claim 1, wherein the control signal further comprises memory use data.

5. A display system according to claim 1, wherein the control signal further comprises brightness and contrast data.

6. A display system according to claim 1, wherein the control signal further comprises colour temperature data.

7. A display system according to claim 1, wherein the display control device is arranged to request the transmission of the control signal.

8. A display system according to claim 1, wherein at least one of the display control devices is integrated in a display device.

9. A method of operating a display system, the display system comprising a plurality of display devices, a plurality of display control devices, each display device connected to at least one display control device, a data processing device and a general purpose data network, the data processing device connected to each display control device via the data network, the method comprising transmitting a control signal from the data processing device to a display control device, the control signal comprising video signal configuration data, the video signal configuration data comprising timing and frequency data.

10. A method according to claim 9, wherein the control signal further comprises power saving data.

11. A method according to claim 9, wherein the control signal further comprises display address data.

12. A method according to claim 9, wherein the control signal further comprises memory use data.

13. A method according to claim 9, wherein the control signal further comprises brightness and contrast data.

14. A method according to claim 9, wherein the control signal further comprises colour temperature data.

15. A method according to claim 9, and further comprising requesting the transmission of the control signal from the display control device.

16. A display system comprising a plurality of display devices, a plurality of display control devices, each display device connected to at least one display control device, a data processing device and a general purpose data network, the data processing device connected to each display control device via the data network, the data processing device being arranged to transmit a control signal to a display control device, the control signal comprising at least one of power saving data, memory use data, brightness and contrast data, color temperature data or display address data.
